(19) United States
(12) Patent Application Publication
(10) Pub. No.: US 2016/0162059 A1
(43) Pub. Date: Jun. 9, 2016

(54) DRIVING CIRCUIT AND DRIVING METHOD FOR USE IN TOUCH DISPLAY SCREEN

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Haijian Teng, Beijing (CN); Yanwen Guo, Beijing (CN)

(21) Appl. No.: 14/589,964

(22) Filed: Jan. 5, 2015

(30) Foreign Application Priority Data
Dec. 5, 2014 (CN) 201410731160.3

(51) Int. Cl. G06F 3/041; G06F 3/01; G06F 3/042

(52) U.S. Cl. CPC G06F 3/041; G06F 3/042; G06F 3/0414; G06F 3/017; G06F 2203/04104

(57) ABSTRACT

A driving method and a driving circuit for use in a touch display screen are disclosed. The driving method comprises the steps of: sensing the number of touch control points; performing driving scanning to the touch display screen in a self capacitance scanning mode when the sensed number of the touch control points is one; and performing driving scanning to the touch display screen in a mutual capacitance scanning mode when the sensed number of the touch control points is more than one.

### FIELD OF THE INVENTION

This disclosure relates to a driving circuit and a driving method for use in a touch display screen, particularly to a driving circuit and a driving method for use in a touch display screen capable of switching between different scanning modes based on the number of the touch control points.

### BACKGROUND OF THE INVENTION

The touch display screen has been more and more applied in personal portable electronic devices such as smart mobile phones by right of its characteristics such as super sensitivity, multi-point touch function and directly operable by fingers.

The touch display screen may comprise two types of self capacitance screen and mutual capacitance screen. The self capacitance screen uses transparent conductive materials like indium tin oxide (ITO) to fabricate arrays of lateral electrodes and vertical electrodes on a glass surface. The generally called self capacitance is formed between these lateral electrodes and vertical electrodes and the ground respectively, i.e., capacitance of electrodes to ground. When the finger of a user touches the self capacitance screen, the capacitance of the finger will enable the capacitance amount of the screen body to increase.

When the user's touch is detected, the self capacitance screen detects the arrays of the lateral electrodes and the vertical electrodes in turn respectively, and determines the lateral coordinates and the vertical coordinates of the touch position respectively based on the capacitance change before and after the touch. In the present application, this kind of scanning mode is called “self capacitance scanning mode”. The touch points can be projected to the X-axis direction and Y-axis direction of the self capacitance screen respectively using the self capacitance scanning mode, then the coordinates of the touch points in the X-axis direction and Y-axis direction are calculated respectively, so as to obtain the positions of the touch points on the self capacitance screen.

FIG. 1 shows a schematic view of the self capacitance screen. For a self capacitance screen constituted by M lateral scanning electrodes and N vertical scanning electrodes, M+N times of scanning are required using the self capacitance scanning mode. If the touch point is a single point, the coordinates of the touch point in the X-axis direction and the Y-axis direction is unique. If there are two (or more) touch points, and the coordinates of respective touch points in the X-axis direction and the Y-axis direction are all different, taking two touch points as example, the respective touch points may have two projections (e.g., X1, X2 and Y1, Y2) in the X-axis direction and the Y-axis direction respectively, thereby four sets of coordinates can be combined, i.e., (X1, Y1), (X1, Y2), (X2, Y1) and (X2, Y2). However, in the four sets of coordinates, only two sets of coordinates are real coordinates of the two touch points, the other two sets of coordinates constitute the so-called “ghost points”, as shown in FIG. 2. Therefore, the self capacitance screen using the self capacitance scanning mode cannot realize real multi-point touch control.

The mutual capacitance screen also uses transparent conductive materials like ITO to fabricate lateral electrodes and vertical electrodes on a glass surface. The difference from the self capacitance screen lies in that a capacitance will be formed at the cross position of the lateral electrode and the vertical electrode, i.e., the lateral electrode and the vertical electrode constitute the two poles of the capacitor respectively. When the finger of a user touches the capacitance screen, the coupling between the two poles (the lateral electrode and the vertical electrode) that constitute the capacitor near the touch point will be influenced, thereby changing the capacitance amount between the two electrodes. When the mutual capacitance is detected, the respective lateral electrodes send excitation signals successively, all the vertical electrodes receive the signals simultaneously, thereby obtaining the capacitance values at the intersections of all the lateral electrodes and the vertical electrodes, i.e., the capacitance values of the whole touch screen on a two-dimensional plane. In the present application, this kind of scanning mode is called “mutual capacitance scanning mode”. The mutual capacitance screen using the mutual capacitance scanning mode can calculate the coordinates of each touch point based on the change amount of the capacitance value of the touch screen on the two-dimensional plane. Therefore, the mutual capacitance screen can realize real multi-point touch control.

FIG. 3 shows a schematic view of a mutual capacitance screen. For a mutual capacitance screen constituted by M lateral electrodes and N vertical electrodes, M*N times of scanning are required using the mutual capacitance scanning mode. Therefore, compared with the self capacitance scanning mode, the power consumption of the mutual capacitance scanning mode is increased greatly.

### SUMMARY OF THE INVENTION

The inventor of the present application has noticed that for a mutual capacitance screen that can realize real multi-point touch control at present, in most of the time, the user only uses one finger to perform the touch control, for example, the user can run a corresponding application only by using a single finger to click on the screen of the smart mobilephone. In such a case, if the mutual capacitance scanning mode is used for the mutual capacitance screen all the time to determine the touch points, many unnecessary power cost may be wasted. Therefore, it is necessary to develop a driving mode that can not only support the real multi-point touch control but also can reduce the power consumption greatly.

The concept of the present invention is proposed with respect to the above technical problem in the prior art. The driving circuit and the driving method according to the concept of the present invention can reduce the power consumption greatly at the same time of realizing real multi-point touch control.

According to one aspect of this disclosure, a driving method for use in a touch display screen is provided, comprising the steps of: sensing the number of touch control points; performing driving scanning to the touch display screen in a self capacitance scanning mode when the sensed number of the touch control points is one; and performing driving scanning to the touch display screen in a mutual capacitance scanning mode when the sensed number of the touch control points is more than one.

According to an embodiment, the number of the touch control points may be sensed with infrared sensors.

According to an embodiment, the infrared sensors may be arranged around the touch display screen.

According to an embodiment, the number of the touch control points may be sensed with pressure sensors.

According to an embodiment, the pressure sensors may be arranged on the touch display screen.

According to an embodiment, the touch display screen may be a mutual capacitance screen.

According to another aspect of this disclosure, a driving circuit for use in a touch display screen is provided, comprising: a gesture sensing module for sensing the number of touch control points; and a central integrated circuit. The central integrated circuit performs driving scanning to the touch display screen in a self capacitance scanning mode when the number of the touch control points sensed by the gesture sensing module is one, and the central integrated circuit performs driving scanning to the touch display screen in a mutual capacitance scanning mode when the number of the touch control points sensed by the gesture sensing module is more than one.

According to an embodiment, the gesture sensing module may comprise infrared sensors.

According to an embodiment, the infrared sensors may be arranged around the touch display screen.

According to an embodiment, the gesture sensing module may comprise pressure sensors.

According to an embodiment, the pressure sensors may be arranged on the touch display screen.

According to an embodiment, the touch display screen may be a mutual capacitance screen.

### BRIEF DESCRIPTION OF DRAWINGS

The features and advantages of respective embodiments will be apparent through the following detailed explanations with reference to the drawings. In the drawings:

FIG. 1 shows a schematic view of a self capacitance screen;

FIG. 2 shows a “ghost point” phenomenon that occurs on a self capacitance screen;

FIG. 3 shows a schematic view of a mutual capacitance screen;

FIG. 4 shows a flow chart of a driving method for use in a touch display screen according to an embodiment;

FIG. 5 shows a block diagram of a driving circuit for use in a touch display screen according to an embodiment; and

FIG. 6 shows a schematic view of a driving circuit for use in a touch display screen according to an embodiment.

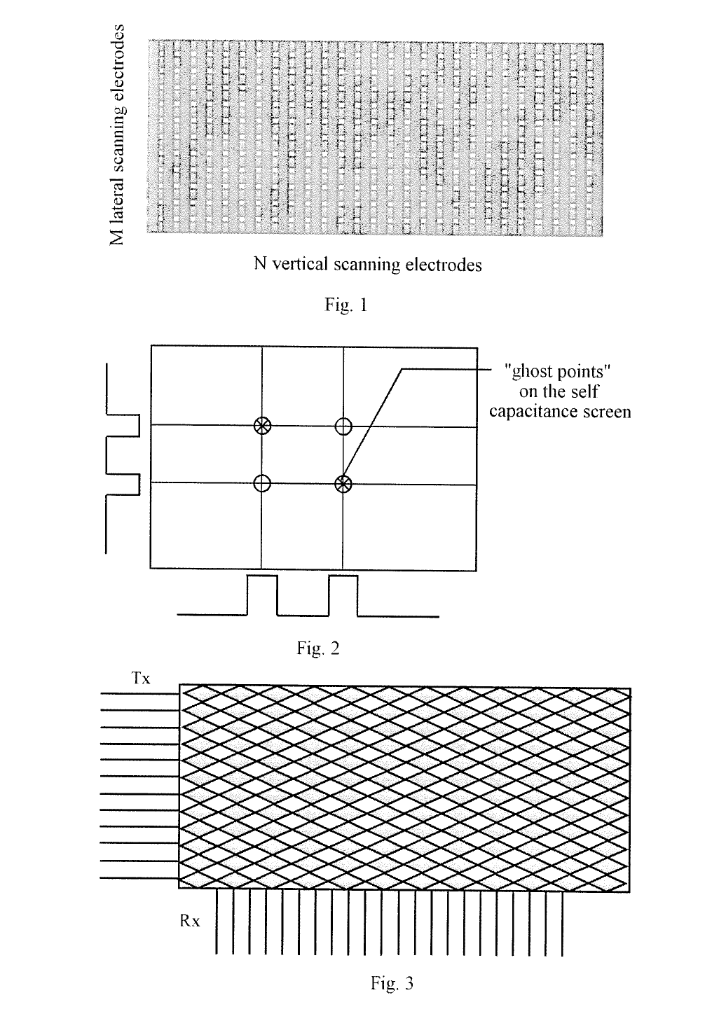

### DETAILED DESCRIPTION OF THE INVENTION

In order to enable the skilled person in the art to understand the concept of the present invention better, the concept of the present invention will be further described in detail in combination with the drawings and the specific embodiments.

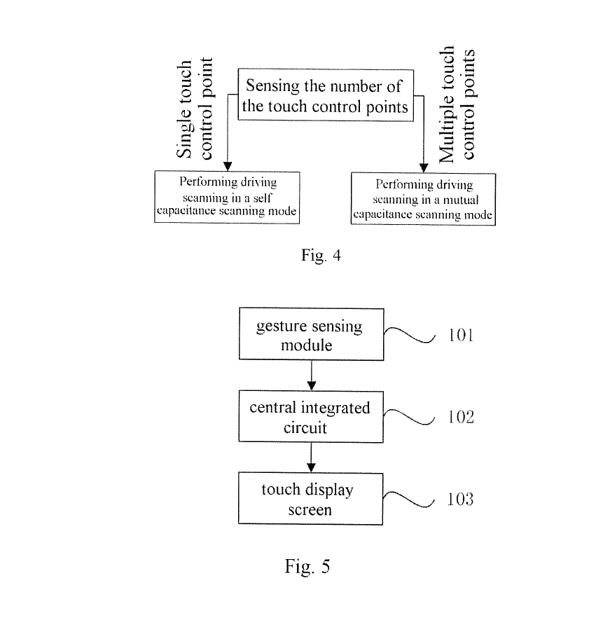

FIG. 4 shows a flow chart of a driving method for use in a touch display screen according to an embodiment.

Referring to FIG. 4, the difference from the driving method in the prior art is that the number of the touch control points is sensed firstly before scanning the touch display screen. The driving scanning can be performed to the touch display screen in a self capacitance scanning mode when the sensed number of the touch control points is only one; the driving scanning can be performed to the touch display screen in a mutual capacitance scanning mode when the sensed number of the touch control points is more than one.

According to the driving method of this disclosure, when the user performs touch control with a single finger, it can be avoided to use the mutual capacitance scanning mode of a relatively high power consumption to perform driving scanning to the touch display screen, thereby reducing the energy consumption and prolonging the use time of the battery; when the user performs multi-point touch control with several fingers, the scanning mode can be switched to the mutual capacitance scanning mode, thereby realizing real multi-point touch control.

According to an embodiment, the touch display screen may be a mutual capacitance screen, so as to realize real multi-point touch control under the mutual capacitance scanning mode.

FIG. 5 shows a block diagram of a driving circuit for use in a touch display screen according to an embodiment.

Referring to FIG. 5, the driving circuit for use in a touch display screen according to this disclosure comprises a gesture sensing module 101 and a central integrated circuit 102. The gesture sensing module 101 is used for sensing the number of the touch control points. The central integrated circuit 102 performs driving scanning to the touch display screen 103 in a self capacitance scanning mode when the number of the touch control points sensed by the gesture sensing module 101 is one, and the central integrated circuit 102 performs driving scanning to the touch display screen 103 in a mutual capacitance scanning mode when the number of the touch control points sensed by the gesture sensing module 101 is more than one.

According to an embodiment, the gesture sensing module 101 may comprise infrared sensors. When the gesture sensing module 101 comprises infrared sensors, the infrared sensors may be arranged around the touch display screen 103, so as to monitor the number of fingers for used in the touch control in real time.

According to an embodiment, the gesture sensing module 101 may comprise pressure sensors. When the gesture sensing module 101 comprises pressure sensors, the pressure sensors may be arranged above the touch display screen 103 so as to monitor the number of fingers for used in the touch control in real time.

The gesture sensing module 101 may transfer the sensed touch control point information to the central integrated circuit 102. The touch control point information may only represent that the number of the touch points is single or multiple. That is to say, when the user performs multi-point touch control, the gesture sensing module 101 does not need to sense the accurate number of the touch control points and the positions of the touch control points, while only transferring the information that “there are multiple touch control points” to the central integrated circuit 102. Similarly, when the user performs single point touch control, the gesture sensing module 101 does not need to sense the position of the touch control point, while only transferring the information that “there is only one touch control point” to the central integrated circuit 102. According to the respective embodiments, a switching value can be used to represent the touch control point information. For example, a high level is used to represent the information that “there are multiple touch control points”, a low level is used to represent the information that “there is only one touch control point”, vice versa. Such a representing manner is only used for explanation rather than limitation to the scope of this disclosure. The skilled person in the art can represent the touch control point information in various appropriate forms based on specific applications.

In response to the received touch control point information, the central integrated circuit 102 performs driving scanning to the touch display screen 103 in an appropriate mode. That is, when the touch control point information represents that “there is only one touch control point”, the central integrated circuit 102 performs driving scanning to the touch display screen 103 in a self capacitance scanning mode; when the touch control point information represents that “there are multiple touch control points”, the central integrated circuit 102 performs driving scanning to the touch display screen 103 in a mutual capacitance scanning mode.

It should be noted that in the context of this disclosure, the terms “self capacitance scanning mode” and the “mutual capacitance scanning mode” are only used for representing two different scanning modes, rather than representing that the scanned touch display screen is a self capacitance screen or a mutual capacitance screen. In deed, in order to realize real multi-point touch control, the touch display screen may be a mutual capacitance screen according to the embodiments, so as to perform multi-point touch control under the mutual capacitance scanning mode.

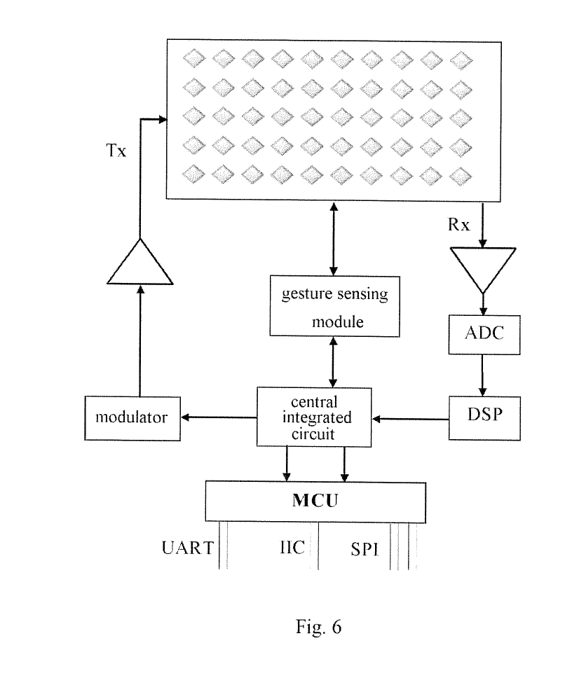

FIG. 6 shows a schematic view of a driving circuit for use in a touch display screen according to an embodiment.

Referring to FIG. 6, when the driving circuit according to this disclosure performs driving, the gesture sensing module determines firstly whether there is a single or multiple touch control points, and transfers the determination result to the central integrated circuit. In response to the determination result transferred from the gesture sensing module, the central integrated circuit switches the driving mode. That is, when the determination result indicates single point touch control, the central integrated circuit switches to the self capacitance scanning mode; when the determination result indicates multi-point touch control, the central integrated circuit switches to the mutual capacitance scanning mode.

According to respective scanning modes, the central integrated circuit generates a corresponding signal and sends it to a modulator. A good pulse signal obtained after being processed by the modulator can serve as a Tx signal to charge the touch display screen. In addition, the received Rx signal is sent to the central integrated circuit after amplification, analog to digital conversion, digital processing, the central integrated circuit can obtain the position information of respective touch control points based on the current scanning mode, i.e., obtaining the position information of a single touch control point under the self capacitance scanning mode; obtaining the position information of multiple touch control points under the mutual capacitance scanning mode. Subsequently, the position information of the touch control points are sent to respective interface modules via the MCU.

According to the driving circuit of this disclosure, when the user performs touch control with a single finger, it can be avoided to use the mutual capacitance scanning mode of a relatively high power consumption to perform driving scanning to the touch display screen, thereby reducing the energy consumption and prolonging the use time of the battery; when the user performs multi-point touch control with several fingers, the scanning mode can be switched to the mutual capacitance scanning mode, thereby realizing real multi-point touch control.

It should be understood that the above embodiments are only exemplary embodiments used for explaining the principle of this disclosure, however, this disclosure is not limited to this. The ordinary skilled person in the art, in the case of not departing from the spirit and substance of this disclosure, can make various modifications and improvements, these modifications and improvements are also deemed as the protection scope of this disclosure.

1. A driving method for use in a touch display screen, comprising steps of:
sensing the number of touch control points;
performing driving scanning to the touch display screen in a self capacitance scanning mode when the sensed number of the touch control points is one; and
performing driving scanning to the touch display screen in a mutual capacitance scanning mode when the sensed number of the touch control points is more than one.

2. The driving method for use in a touch display screen according to claim 1, wherein the touch display screen is a mutual capacitance screen.

3. The driving method for use in a touch display screen according to claim 1, wherein the number of the touch control points is sensed with infrared sensors.

4. The driving method for use in a touch display screen according to claim 3, wherein the infrared sensors are arranged around the touch display screen.

5. The driving method for use in a touch display screen according to claim 4, wherein the touch display screen is a mutual capacitance screen.

6. The driving method for use in a touch display screen according to claim 1, wherein the number of the touch control points is sensed with pressure sensors.

7. The driving method for use in a touch display screen according to claim 6, wherein the pressure sensors are arranged on the touch display screen.

8. The driving method for use in a touch display screen according to claim 7, wherein the touch display screen is a mutual capacitance screen.

9. A driving circuit for use in a touch display screen, comprising:
a gesture sensing module for sensing the number of touch control points; and
a central integrated circuit,
wherein the central integrated circuit performs driving scanning to the touch display screen in a self capacitance scanning mode when the number of the touch control points sensed by the gesture sensing module is one, and the central integrated circuit performs driving scanning to the touch display screen in a mutual capacitance scanning mode when the number of the touch control points sensed by the gesture sensing module is more than one.

10. The driving circuit for use in a touch display screen according to claim 9, wherein the touch display screen is a mutual capacitance screen.

11. The driving circuit for use in a touch display screen according to claim 9, wherein the gesture sensing module comprises infrared sensors.

12. The driving circuit for use in a touch display screen according to claim 11, wherein the infrared sensors are arranged around the touch display screen.

13. The driving circuit for use in a touch display screen according to claim 12, wherein the touch display screen is a mutual capacitance screen.

14. The driving circuit for use in a touch display screen according to claim 9, wherein the gesture sensing module comprises pressure sensors.

15. The driving circuit for use in a touch display screen according to claim 14, wherein the pressure sensors are arranged on the touch display screen.

16. The driving circuit for use in a touch display screen according to claim 15, wherein the touch display screen is a mutual capacitance screen.
